(19) United States
(12) Patent Application Publication
(10) Pub. No.: US 2002/0109673 A1
(43) Pub. Date: Aug. 15, 2002

(54) Method and apparatus employing angled single accelerometer sensing multi-directional motion

(76) Inventor: Thierry Valet, Sunnyvale, CA (US)

Correspondence Address: OPPENHEIMER WOLFF & DONNELLY, P. O. BOX 10356, PALO ALTO, CA, 94303, US

(21) Appl. No.: 10/040,254

(22) Filed: Jan. 4, 2002

Related U.S. Application Data
(60) Provisional application No. 60/259,666, filed on Jan. 4, 2001.

(51) Int. Cl. G09G 5/08

(52) U.S. Cl. 345/158

(57) ABSTRACT

Disclosed is a method and apparatus for detecting acceleration in several planes of motion while using only one accelerometer chip. The accelerometer chip is mounted to the circuit board at some angle so as to allow for multiple directional sensing. In another embodiment the circuit board itself may be slanted thereby allowing the chip to sense motion in multiple planes of motion. The disclosed method may be used in a device such as a personal digital assistant (PDA).

### CROSS REFERENCE TO RELATED APPLICATIONS

Reference is made and priority claimed to U.S. Provisional Application entitled SELECTIVE ACCESS NON-DOD DIGITAL DATA BROADCAST SYSTEM, filed Nov. 30, 2001.

### BACKGROUND OF THE INVENTION

The present invention relates to the use and mounting of accelerometers in user interface devices such as PDA'S. Specifically, this invention discloses mounting an accelerometer chip at an angle with respect to the circuit board to allow for sensing acceleration in more than one plane of motion. One type of device in which this invention may be used is in a PDA (Personal Digital Assistant).

In the last few decades, enormous progress has occurred in developing and perfecting interactions between humans and computer systems. Improvements in user interfaces along with improvements in data capacity, display flexibility, and communication capabilities have lead to the use of accelerometers in such interfaces. For example, U.S. Pat. No. 4,445,376 issued on May 1, 1984,discloses an arrangement in which three accelerometers supply output signals that can be processed to provide the specific force components and the angular rate components relative to each axis of a right hand Cartesian coordinate system that is fixed within a moving body. In this arrangement, each accelerometer is mounted so that the force sensitive axis of the accelerometer is parallel to an axis of the coordinate system (e.g., the X axis). In addition each accelerometer is mounted (or internally configured) so that the force sensitive axis rotates at a uniform rate about a fixed axis which is parallel to and spaced apart from the force sensitive axis. As the object with which the coordinate system is associated moves in space, the signal that is generated by each accelerometer includes a component representative of specific force along the coordinate direction in which the accelerometer force sensitive axis points and signal components representative of angular rate relative to the coordinate axes that are perpendicular to the accelerometer force sensitive axis. For example, the accelerometer that generates a signal representative of the X axis component of specific force and the Y and Z axes components of angular rate has the force sensitive axis of the accelerometer parallel to the X axis and rotates about a fixed axis of the coordinate system so that the force sensitive axis remains parallel to the X axis and circles the fixed axis at a constant radius.

The above-referenced patent application also discloses three arrangements wherein a pair of accelerometers is associated with a coordinate axis of a moving body to generate a signal that can be processed to obtain the specific force component relative to one coordinate axis of the body and the angular rate component for a different coordinate axis of the body. In one of these paired accelerometer arrangements, the force sensitive axes of the two accelerometers are parallel to one another and parallel to the coordinate axis for which a specific force measurement is to be obtained. In addition, the accelerometers are positioned such that the force sensitive axis of each accelerometer is equally spaced apart from a second coordinate axis and is perpendicular to a line that extends through the second coordinate axis. In this arrangement, the accelerometers are driven or internally configured so that the force sensitive axes of the accelerometers cyclically rotate through a small angle of deflection. This causes the force sensitive axes of the two accelerometers to cyclically move back and forth along lines that are equally spaced apart from the second coordinate axis. For example, in such an arrangement, the force sensing axes of a pair of accelerometers that are mounted for providing a signal that can be processed to obtain the X axis component of specific force and the Y axis component of angular rate are: (a) equally spaced apart from the Z coordinate axis; (b) mounted with the force sensitive axes extending in the X direction; and, (c) configured and arranged so that the accelerometer force sensing axes move cyclically back and forth along arcuate paths (chords of a circle) that approximate straight lines that are parallel to the Z axis and lie in the Y-Z plane.

In summary, it is necessary in prior art systems to provide one accelerometer for each desired plane of motion, i.e. 3 accelerometers for the X, Y, and Z directions, respectively. Requiring three accelerometers is a major drawback of these prior art systems to due to the fact that it is expensive and uses valuable space is small devices. Additional space is required of these devices because some of the accelerometers must be mounted perpendicular to the circuit board.

It is the object of the present invention to sense acceleration in many directions as described above, however, accomplishing this with fewer accelerometers. It is also an object of the present invention to minimize the cost and space requirements of these types of devices employing accelerometers.

### SUMMARY OF THE INVENTION

The present invention addresses the aforementioned problems by providing a single accelerometer chip placed at an angle with respect to the circuit board or other electronic component which allows relative motion to be measured in multiple planes. The angle of the accelerometer chip is optimized for height and size constraints of the device in which it is placed. The present invention allows the hand-held device to remain small while sensing motion in multiple planes.

### BRIEF DESCRIPTION OF THE DRAWINGS

FIG. 1 displays a prior art system including a traditional computer human interface and a Personal Digital Assistant;

FIG. 2 displays a prior art Personal Digital Assistant in typical operation;

FIG. 3 depicts a hand held computer with an attachment incorporating a motion sensor in accordance with one embodiment of the current invention and the motion template to be used hereafter to describe the user's control interaction;

FIG. 4 depicts the prior art of multiple orthogonal accelerometers in an electronic device;

FIG. 5 depicts a system block diagram in accordance with one preferred embodiment of the current invention with an embedded database incorporated in the processor and local motion sensor;

FIG. 6 depicts the circuit board on which the accelerometer is mounted for 2-dimentional motion sensitivity;

FIG. 7 depicts the circuit board diagram on which the accelerometer can be mounted for 3-dimentional motion sensitivity;

FIG. 8 depicts a slanted circuit board on which an accelerometer chip may be mounted.

### DETAILED DESCRIPTION OF THE INVENTION

Traditional computer human interfaces 10 exist in a variety of shapes and forms including desktop computers, remote terminals, and portables such as laptop computers, notebook computers, hand held computers, and wearable computers.

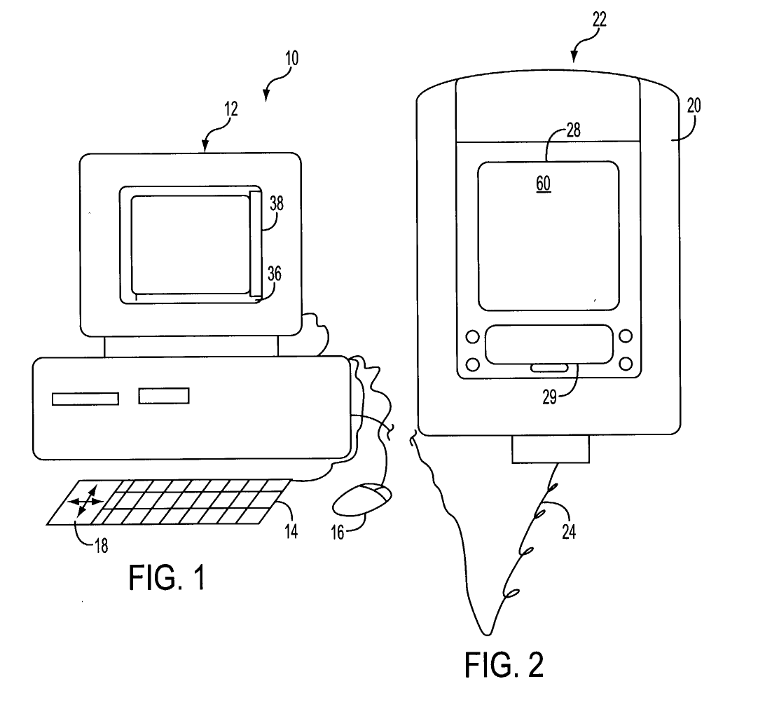

In the beginning of the personal computer era, there was the desktop computer, which is still in use today. FIG. 1 displays a traditional desktop computer human interface 10 and a Personal Digital Assistant 20. The traditional computer 10 typically includes a display device 12, a keyboard 14, and a pointing device 16. The display device 12 is normally physically connected to the keyboard 14 and pointing device 16. The pointing device 16 and buttons 18 may be physically integrated into the keyboard 14.

In the traditional desktop computer human interface 10, the keyboard 14 is used to enter data into the computer system. In addition, the user can control the computer system using the pointing device 16 by making selections on the display device 12. For example, using the pointing device the user can scroll the viewing area by selecting the vertical 38 or horizontal 36 scroll bar. Although the desktop computer was sufficient for the average user, as manufacturing technology increased, personal computers began to become more portable, resulting in notebook and hand held computers.

Notebook and hand held computers are often made of two mechanically linked components, one essentially containing the display device 12 and the other, the keyboard 14 and pointing device 16. Hinges often link these two mechanical components, often with flexible ribbon cabling connecting the components and embedded in the hinging mechanism. The two components can be closed like a book, often latching to minimize inadvertent opening. The notebook greatly increased the portability of personal computers. However, in the 1990's, a new computer interface paradigm began which gave even greater freedom, known as the Personal Digital Assistant (PDA hereafter) 20.

One of the first commercially successful PDAs was the Palm product line manufactured by 3Com. These machines are quite small, lightweight and relatively inexpensive, often fitting in a shirt pocket, weighing a few ounces, and costing less than $400 when introduced. These machines possess very little memory (often less than 2 megabytes), a small display 28 (roughly 6 cm by 6 cm) and no physical keyboard. The pen-like pointing device 26, often stored next to or on the PDA 20, is applied to the display area 28 to support its user making choices and interacting with the PDA device 20. External communication is often established via a serial port in the PDA connecting to the cradle 22 connected by wire line 24 to a traditional computer 10. As will be appreciated, PDAs such as the PalmPilot™ have demonstrated the commercial reliability of this style of computer interface.

FIG. 2 displays a prior art Personal Digital Assistant 20 in typical operation, in this case, strapped upon the wrist of its user. At least one company, Orang-otang Computers, Inc. sells a family of wrist mountable cases for a variety of different PDAs. The pen pointer 26 is held in one hand and the PDA 20 is on the wrist of the other hand. The display area 28 is often quite small compared to traditional computer displays 12. In the case of the Palm product line, the display area 28 contains an array of 160 pixels by 160 pixels in a 6 cm by 6 cm viewing area. Often, part of the display area is further allocated to menus and the like, further limiting the viewing area for a 2-D object such as a FAX page. However, this problem has been partially addressed. The menu bar 34 found on most traditional computer-human interface displays 12 is usually invisible on a PDA display 28 except when a menu button 29 is pressed.

Central to this invention is the concept that motion of a display device controls an object viewer, where the object being viewed is typically essentially stationary in virtual space in the plane surrounding the display device. Motion sensing of the display may be done by a variety of different approaches including mounting an accelerometer chip at an angle with respect to a circuit board and also by having an angled circuit board as will be described in greater detail.

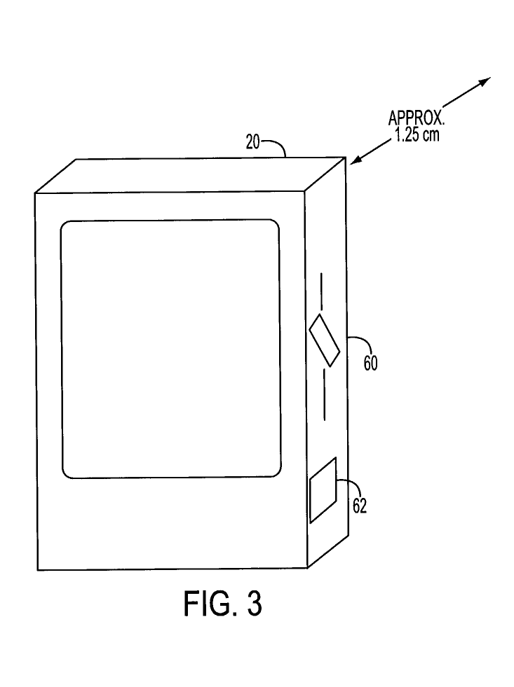

FIG. 3 depicts a hand held computer 20 in accordance with one embodiment of the current invention, including an attachment 60 incorporating a motion sensor. Also included in FIG. 3 is a motion template 62 to be used hereafter to describe the user's control interaction. Note that in some preferred embodiments, a motion sensor may be embedded into the hand held device and an add-on attachment 60 would be rendered unnecessary. The hand held computer 20 is considered to have a processor internal to the case 20 controlling the display device 28.

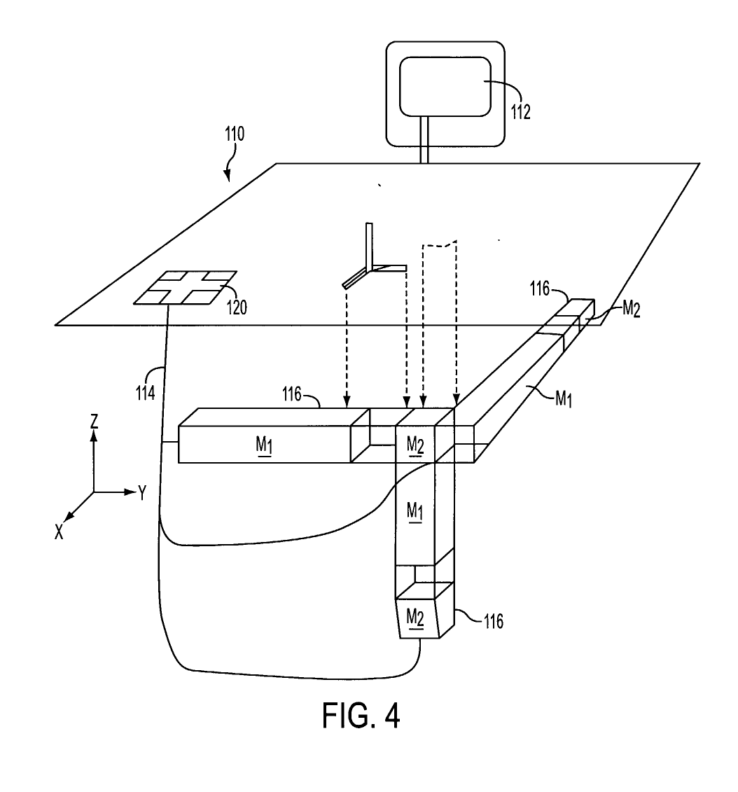

The motion sensor incorporated in attachment 60, or possibly found internal to the hand held device, would preferably include a mechanism providing the internal processor with a motion vector measurement. Note that the motion sensor in prior art devices may be further composed of multiple subsidiary sensors, for example, a network of two or three accelerometers in a rigid orthogonal arrangement would preferably possess independent offset controls. Such subsidiary sensors may not be identical in structure or function. FIG. 4 depicts such system. The processor 110 incorporates an embedded database 120. Coupled to the processor via connection 114 are motion sensors 116. Also coupled to the processor via connection 112 is a display device 118.

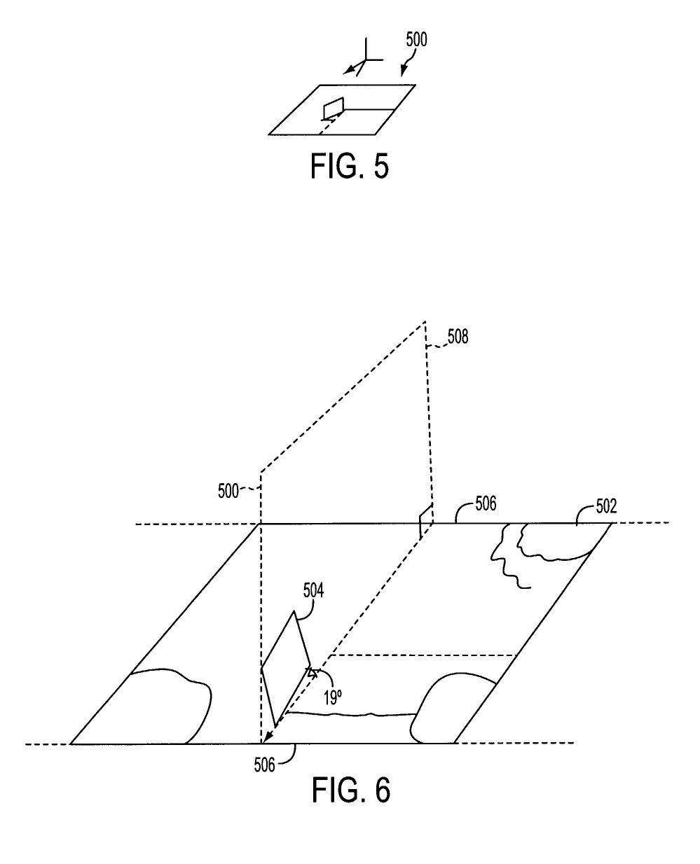

FIG. 5 shows a block diagram 500 of how the mutlidimentional sensing accelerometer chip interacts with the electronic device.

A more detailed description of the preferred embodiment is shown in FIG. 6. FIG. 6 provides a 2-dimentional sensing accelerometer system 500. An accelerometer chip 504, is mounted on a circuit board 502. As described in the background section, it is common to securely mount integrated circuit chips flat onto the circuit board, or perpendicular to the circuit board. In other words one accelerometer chip is need for each individual plane of motion sensing. Therefore it is common to provide 3 accelerometer chips all mounted perpendicular to each other to sense motion in the X, Y, and Z directions. The preferred embodiment of the instant invention mounts a single accelerometer chip at some angle “theta” 506 with respect to the plane of the circuit board 502 or the plane perpendicular to the circuit board 508. Mounting the chip at an angle allows the accelerometer to be sensitive of motion in more than one plane. For example, if one thinks of an X and Y Cartesian coordinate system, an accelerometer may sense acceleration which can be represented by a vector in the X and Y coordinate system by accounting for the angle at which the chip is placed. If the accelerometer is mounted in such a way as to creating a vector that has X, and Y components, this essentially means that the accelerometer is sensitive in both of these directions or planes.

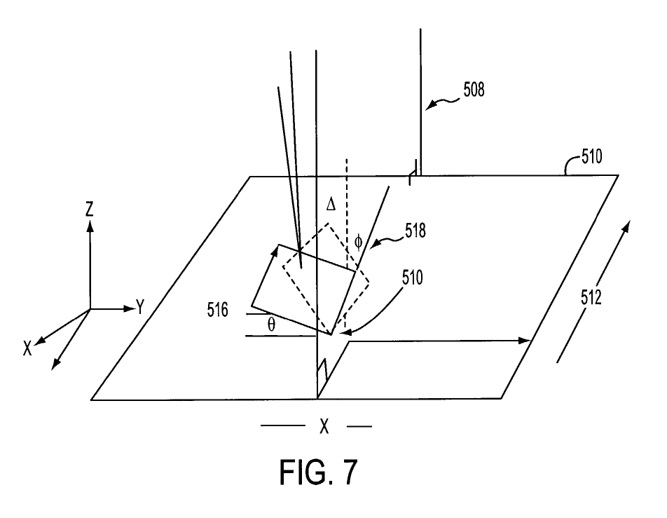

FIG. 7 depicts an accelerometer configuration system 510 which allows motion or acceleration to be sensed by a single chip not only in the X-Y plane of the circuit board 512, but also in the Z direction. The accelerometer chip 514 is not only mounted with an angle “theta” 516 with respect to the X and Y planes (or the plane perpendicular) as described above, but also with an angle to the Z-axis known as “phi.” 518

It is also a further feature of the instant invention described in both FIGS. 6 and 7 that in order to minimize the physical space of the device (also known as minimizing the Z footprint), the angles “phi” and “theta” at which the chip is mounted is 19 degrees with respect to the circuit board. This angle allows for accurate sensing in other planes of motion while minimizing the height of the device in the orthogonal direction and the error calculated from magnifying such vector components for calculation.

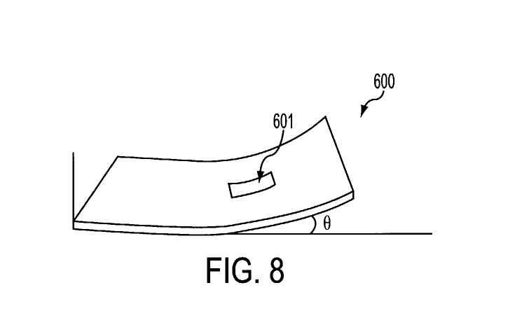

Another embodiment of the invention is shown in FIG. 8. In this embodiment the circuit board 600 is slanted and the accelerometer chip 601 is mounted to the slanted surface. The slanted surface accomplishes the same function as mounting the chip at an angle as shown in FIGS. 6 and 7. The slanted surface therefore allows components of motion to be detected in more than one plane. As described in FIG. 6 and 7, an optimum angle of circuit board will maximize directional sensing while minimizing device size.

Although only a few embodiments of the present invention have been described in detail, it should be understood that the present invention may be embodied in many other specific forms without departing from the spirit or scope of the invention. Therefore, the present examples are to be considered as illustrative and not restrictive, and the invention is not to be limited to the details given herein, but may be modified within the scope of the appended claims.

We claim:

1. A hand-held device comprising:
a circuit board;
a processor means attached to said circuit board;
a tracking means for sensing movements of the device wherein the tracking means contains an accelerometer chip mounted at an angle with respect to the circuit board.

2. A hand held device as recited in claim 1 wherein the device is a personal digital assistant (PDA).

3. A hand held device as recited in claim 1 wherein the tracked movements are used to control a display.

4. A hand held device as recited in claim 1 wherein the angle formed between the accelerometer chip and the circuit board is 19 degrees.

5. A hand held device as recited in claim 1 wherein the orientation of the certain portion displayed is redefined in response to a request by a user.

6. A method of mounting an integrated circuit chip onto a circuit board comprising the steps of providing a circuit board onto which electrical components will be mounted; and mounting an accelerometer chip onto said circuit board so that an angle is formed between said circuit board and said accelerometer chip.

7. A computer implemented method as recited in claim 6 wherein the accelerometer chip is mounted at an angle of 19 degrees with respect to the circuit board.

8. A computer implemented method as recited in claim 6 wherein acceleration may be detected in more than one plane of motion.

9. A computer implemented method as recited in claim 6 wherein the scalability feature is controlled by user input separate from tracked movement of the display device.

10. A computer implemented method as recited in claim 6 wherein the navigation capability of the physical map includes a scalability feature allowing adjustment of the scalability of the physical map in order to provide a viewer of the display device views of the physical map having different magnifications

11. A method of measuring acceleration in more than one plane of motion comprising the steps of; providing a circuit board on which electrical components will be mounted, mounting an accelerometer chip onto said circuit board wherein an angle is formed between the circuit board and the accelerometer chip.

12. A method as recited in claim 11 further comprising the step of mounting a single accelerometer chip at an angle of 19 degrees with respect to a circuit board.

13. A method as recited in claim 11 wherein the single accelerometer chip is capable of sensing motion in more than one plane due to said angle.

14. A method as recited in claim 11 wherein the accelerometer produces signals used to control an electrical device.

15. A method as recited in claim 14 wherein the device is a personal digital assistant (PDA).

16. A hand-held device comprising; a circuit board that contains a slanted surface; and an accelerometer chip mounted on said slanted surface.

17. A hand-held device as in claim 16,

18. A hand-held device as in claim 16, wherein the device is a hand-held personal digital assistant (PDA).

19. A computer implemented method as recited in claim 15 wherein the handheld computer device is a personal digital assistant (PDA).

20. A computer implemented method as recited in claim 16 wherein the PDA has handwriting recognition capability.
